(19) United States
(12) Patent Application Publication
(10) Pub. No.: US 2009/0237396 A1
(43) Pub. Date: Sep. 24, 2009

(54) SYSTEM AND METHOD FOR CORRELATING AND SYNCHRONIZING A THREE-DIMENSIONAL SITE MODEL AND TWO-DIMENSIONAL IMAGERY

(75) Inventors: Joseph A. VENEZIA, Orlando, FL (US); Thomas J. APPOLLONI, Melbourne, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Corporation of the State of Delaware, Melbourne, FL (US)

(21) Appl. No.: 12/053,756

(22) Filed: Mar. 24, 2008

(51) Int. Cl. G06T 15/00

(52) U.S. Cl. 345/419; 345/581

(57) ABSTRACT

An imaging system includes a 3D database for storing data relating to three-dimensional site model images having a vantage point position and orientation when displayed. A 2D database stores data relating to a two-dimensional image that corresponds to the vantage point position and orientation for the three-dimensional site model image. Both the three-dimensional site model image and two-dimensional imagery are displayed typically on a common display A processor operative with the two-dimensional and three-dimensional databases and will create and display the three-dimensional site model image and two-dimensional imagery from data retrieved from the 2D and 3D databases and correlates and synchronizes the three-dimensional site model image and two-dimensional imagery to establish and maintain a spatial orientation between the images as a user interacts with the system.

### FIELD OF THE INVENTION

The present invention relates to the field of imaging and computer graphics, and more particularly, this invention relates to a system and method for correlating and synchronizing a three-dimensional site model and two-dimensional imagery.

### BACKGROUND OF THE INVENTION

Some advanced imaging systems and commercially available software applications display two-dimensional imagery, for example, building interiors, floor plan layouts and similar two-dimensional images, and also display three-dimensional site model structures to provide spatial contextural information in an integrated environment. There are some drawbacks to such commercially available systems, however. For example, a majority of photogrametrically produced three-dimensional models have no interior details. A familiarization with building interiors while viewing a three-dimensional model would be useful to many users of such applications, for example, for security and similar applications. Some software imaging applications display interior images that give detail without site reconstruction and are becoming more readily available, but even these type of software imaging applications are difficult to manage and view in a spatially accurate context. A number of these applications do not have the imagery geospatially referenced to each other and it is difficult to identify what a user is looking at when viewing the images. For example, it is difficult for the user to determine which room or rooms are contained in any given image, especially when there are many similar images that make it difficult for a user to correlate and synchronize between the various images, especially when the user pans or rotates an image view.

Some interior imaging systems, for example, those having power to display 360-degree panoramic images, can capture interior details It is difficult, however, even in these software applications, to comprehend what any given portion of an image references, for example, which room is displayed or which hallway is displayed within the image or which room is next to which room, and what is behind a given wall. This becomes even more difficult when the rooms and hallways in a building look similar such that a user has no bearing or common reference to use for orientation relative to the different hallways and rooms within the building. It is possible to label portions of the image with references so the user understands better what they are looking at, but this does not sufficiently solve this problem, which is further magnified when there are dozens of similar images.

For example, FIG. 1 at 10 shows two panoramic images 12, 14 of similar looking, but separate areas in a building. Both images having no geospatial context, making it difficult to determine where the user is located relative to the different rooms, open spaces, and hallways when viewing the two different, but similar looking panoramic images 12, 14.

Some imaging applications provide a two-dimensional layout of a building floor plan with pop-ups that show where additional information is available, or provide an image captured at a specific location within a building, but provide no orientation as to the layout of the building. For example, a system may display a map of a site and contain markers, which a user could query or click-on to obtain a pop-up that shows an interior image of that respective area. Simply querying or clicking-on a marker in a serial manner, however, does not give the user the context of this information concerning the location the user is referenced at that site. Furthermore, it is difficult to comprehend the contents of an image that contains many rooms or unique perspectives. Sometimes images may be marked-up to provide some orientation, but any ancillary markers or indicia often clutters the image. Even with markers, these images still would not show how components within the image relate to each other.

One proposal as set forth in U.S. Patent Publication No. 2004/0103431 includes a browser that displays a building image and icon hyperlinks that display ancillary data. It does not use a three-dimensional model where images and plans are geospatially correlated. As disclosed, the system is directed to emergency planning and management in which a plurality of hyperlinks are integrated with an electronic plan of the facility. A plurality of electronic capture-and-display media provide visual representations of respective locations at the facility. One of the electronic capture-and-display media is retrieved and played in a viewer, after a hyperlink associated with the retrieved media is selected. The retrieved media includes a focused view of a point of particular interest, from an expert point of view.

### SUMMARY OF THE INVENTION

An imaging system includes a 3D database for storing data relating to three-dimensional site model images having a vantage point position and orientation when displayed. A 2D database stores data relating to a two-dimensional image that corresponds to the vantage point position and orientation for the three-dimensional site model image. Both the three-dimensional site model image and two-dimensional image are displayed typically on a common display. A processor operative with the two-dimensional and three-dimensional databases and display will create and display the three-dimensional site model image and two-dimensional image from data retrieved from the 2D and 3D databases and correlates and synchronizes the three-dimensional site model image and two-dimensional image to establish and maintain a spatial orientation between the images as a user interacts with an image.

The imaging system includes a graphical user interface in which the three-dimensional site model and two-dimensional images are displayed. The three-dimensional site model image could be synchronized with a panoramic view obtained at an image collection point within a building interior. The two-dimensional images include a floor plan image centered on the collection point within the building interior. The processor can be operative for rotating the panoramic image and updating the floor plan image with a current orientation of the panoramic image.

A dynamic heading indicator can be displayed and synchronized to a rotation of the three-dimensional site model image. The processor can update at least one of the 2D and 3D databases based upon additional information obtained while a user interacts with an image. The 2D database can be formed of rasterized vector data and the 3D database can include data for a local space rectangular or world geocentric coordinate systems. Both the 2D and 3D databases can store ancillary data to the 2D database and 3D database and provide additional data that enhances an image during user interaction with an image.

An imaging method is also set forth.

### BRIEF DESCRIPTION OF THE DRAWINGS

Other objects, features and advantages of the present invention will become apparent from the detailed description of the invention which follows, when considered in light of the accompanying drawings in which:

FIG. 1 is a view showing two images juxtaposed to each other and looking at similar looking but separate areas within the same building where both images are without geospatial context to each other, showing the difficulty from a user point of view in determining a position within the building as a reference.

FIG. 2 is a high-level flowchart illustrating basic steps used in correlating and synchronizing a three-dimensional site model image and two-dimensional image in accordance with a non-limiting example of the present invention.

FIG. 3 is a computer screen view of the interior of a building and showing a panoramic image of a three-dimensional site on the right side of the screen view in a true three-dimensional perspective and a two-dimensional image on the left side as a floor plan that is correlated and synchronized with the panoramic image and the three-dimensional site model in accordance with a non-limiting example of the present invention.

FIGS. 4 and 5 are flowcharts for an image database routine such as RealSite™ that could be used in conjunction with the system and method described relative to FIGS. 2 and 3 for correlating and synchronizing the three-dimensional site model image and two-dimensional images in accordance with a non-limiting example of the present invention.

FIG. 6 is a layout of individual images of a building and texture model that can be used in conjunction with the described RealSite™ process.

FIG. 7 is a flowchart showing the type of process that can be used with the image database routine for shown in FIGS. 4 and 5.

### DETAILED DESCRIPTION OF THE PREFERRED EMBODIMENTS

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art. Like numbers refer to like elements throughout.

In accordance with a non-limiting example of the present invention, the system and method correlates and synchronizes a three-dimensional site model and two-dimensional imagery with real or derived positional metadata, for example, floor plans, panoramic images, video and similar images to establish and maintain a spatial orientation between the images, such as formed from disparate data sets. For example, a two-dimensional floor plan image could be displayed as centered on a collection point of a three-dimensional site model image as a panoramic image and the collection point marked on the three-dimensional site model image. As the panoramic image is rotated, the floor plan is updated with a current orientation. This process can associate ancillary information to components within the image such as the room identification, attributes and relative proximities.

Correlation, of course, can refer to the correspondence between the two different images such that the reference point as a collection point for a panoramic image, for example, will correspond or correlate to the spatial location on the two-dimensional image such as a floor plan. As a user may rotate a panoramic image and the two-dimensional image will be synchronized such that the orientation may change in the two-dimensional image, for example, a line or indicator pointing in the direction of the rotation or other similar marker. The speed and image changes would be synchronized as a user interacts with a two-dimensional image and the three-dimensional image changes or when the user interacts with the other image.

Interior images can be located on the three-dimensional site model image at the point the imagery was originally captured at a collection point. From within the immersive three-dimensional environment, at these identified collection points, the user can view the image at the same perspective and spatial orientation of the three-dimensional site model image. Each image can have information associated with it, such as its spatial position and the collection azimuth angle. This information is used to synchronize it with one or other two-dimensional images and to correlate all the images to the three-dimensional model. For example, a portion of a floor plan correlated to where a panoramic image was taken as a collection point with the floor plan can have a dynamic heading indicator synchronized to the rotation of the panoramic image. Information correlated in this manner makes it more intuitive from a user's point of view to recognize from the two-dimensional images what portion of the three-dimensional site model is being explored, as well as those portions that are adjacent, orthogonal or hidden from the current viewing position. The system and method in accordance with a non-limiting example of the present invention accurately augments the data providing the three-dimensional site model and provides a greater spatial awareness to the images. It is possible to view a three-dimensional site model image, panoramic image, and two-dimensional image. These images are correlated and synchronized.

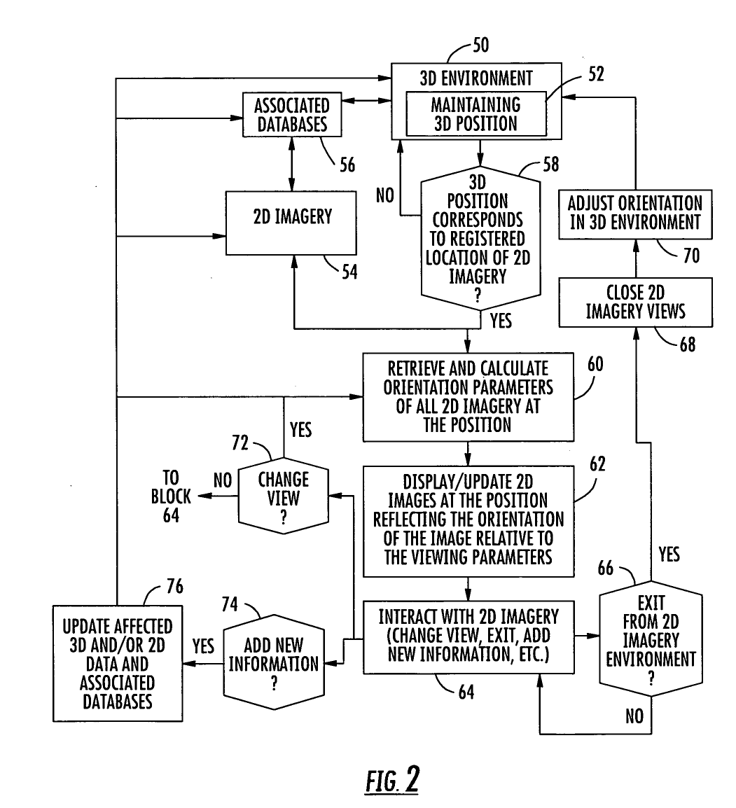

FIG. 2 is a high-level flowchart illustrating basic components and steps for the system and method as described in accordance with a non-limiting example of the present invention. Block 50 corresponds to a database storing data for the three-dimensional environment or site model and includes data sets for accurate three-dimensional geometric structures and imagery spanning a variety of coordinate systems such as a Local Space Rectangular (LSR) or World Geocentric as a non-limiting example. A user may open a screen window and a processor of a computer, for example, processes data from the database and brings up a three-dimensional site model image. During this process, the user's vantage point position and orientation within the three-dimensional site model image are maintained as at block 52. As known to those skilled in the art, the LSR coordinate system is typically a Cartesian coordinate system without a specified origin and is sometimes used for SEDRIS models where the origin is located on or within the volume of described data such as the structure. The relationship (if any) between the origin and any spatial features are described and determined typically by inspection. A Geocentric model, on the other hand, places the user at the center reference making any views for the user as the vantage point.

Another block 54 shows the two-dimensional imagery as a database or data set that could be available in different forms, including rasterized vector data, including floor plans, and interior images, panoramic images, and video sequences. This data set is correlated and synchronized such that any reorientation or interaction with any of the two-dimensional image content prompts the system to synchronize and update any other two-dimensional and three-dimensional orientation information.

The associated databases 56 can represent ancillary data or information to the two-dimensional and three-dimensional data sets and can supply auxiliary/support data that can be used to enhance either environment. The associated databases 56 can be updated based upon different user interactions, including any added notations supplied by the user and additional image associations provided by the system or by the user, as well as corresponding similar items.

Typically with rasterized vector data, the raster representation divides an image into arrays of cells or pixels and assigns attributes to the cells. A vector based system, on the other hand, displays and defines features on the basis of two-dimensional Cartesian coordinate pairs (such as X and Y) and computes algorithms of the coordinates. Raster images have various advantages, including a more simple data structure and a data set that is compatible with remotely sensed or scanned data. It also uses a more simple spatial analysis procedure. Vector data has the advantage that it requires less disk storage space. Topological relationships are also readily maintained. The graphical output with vector based images more closely resembles hand-drawn maps.

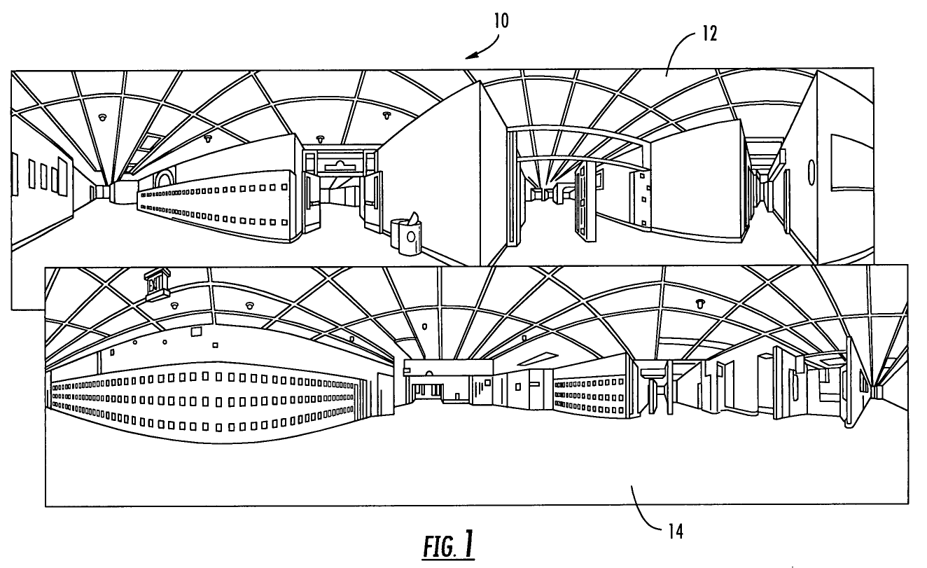

As shown in the flowchart, while a user is in the three-dimensional environment and spanning or rotating an image or otherwise maintaining position (block 52), for example, as shown in one of the images of FIG. 1, the process begins with a determination of whether the three-dimensional position corresponds to a registered location of the two-dimensional image (block S8). If not, then the computer screen or other image generating process maintains the three-dimensional position (block 52), for example, as shown in FIG. 1.

If that three-dimensional position corresponds to a registered location of the two-dimensional imagery, the system retrieves and calculates the orientation of parameters of all two-dimensional imagery at this position (block 60). The system displays and updates any two-dimensional images at this position reflecting the orientation of the image relative to any viewing parameters (block 62) At this point, the user interacts with the two-dimensional imagery and moves along the two-dimensional image, changing views or adding new information. The viewing parameters could be specified by the user and/or the system during or after image initialization. The user interacts with the two-dimensional imagery and can change, view, exit, or add new information to a database and perform other similar processes (block 64).

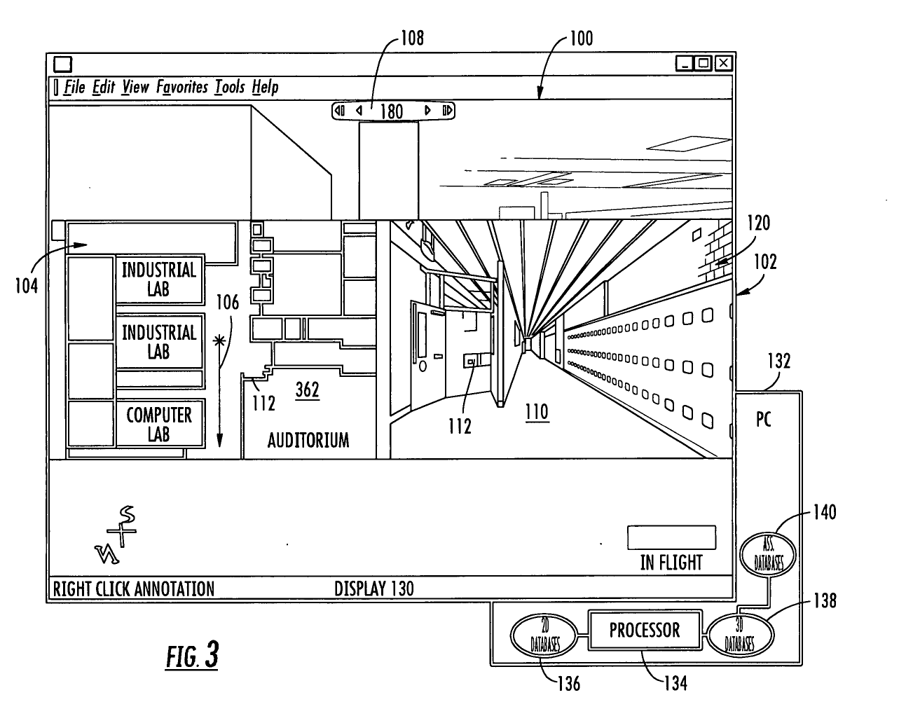

At this time, the system determines if the user desires to exit from the two-dimensional imagery environment (block 66), and if yes, then the two-dimensional image views are closed depending on the specific location of the user relative to the two-dimensional image (block 68). The orientation in the three-dimensional environment is then adjusted, for example, relative to where the user might be positioned on the two-dimensional image (block 70). An example is explained later with reference to FIG. 3.

Referring now again to block 64 where the user has both two-dimensional and three-dimensional screen images as shown in FIG. 3, a determination is made if the view is to be changed (block 72), and if yes, then the system and method retrieves and calculates orientation parameters of all two-dimensional imagery at this position (block 60) and the process continues. If not, the process continues as before such (block 64). A determination can also be made if new information is to be added (block 74), and the affected three-dimensional data set and/or two-dimensional data set and associated databases are updated (block 76) as signified with the arrows to the two-dimensional imagery database or data set (block 54), associated databases (block 56) and three-dimensional environment database or data set (block 52).

Referring now to FIG. 3, an example of a screen image or shot of a graphical user interface 100 is shown, such as displayed on a monitor at a user computer system, for example, a personal computer running the software for the system and method as described. The screen view shows the interior structure of a building from a true three-dimensional perspective as a panoramic view shown on the right-hand image 102 of the graphical user interface 100. Because the three-dimensional interior imagery is available at certain locations within the building, this screen image is automatically presented at an appropriate location as shown in the two-dimensional floor plan image 104 on the left, showing a plan view of where the user is located by the arrow 106. In this case, the user is heading south as indicated by the 180-degree dynamic heading indicator 108 at the top portion of the image. The floor plan image 104 on the left indicates this orientation with its synchronized heading arrow 106 pointing south or 180 degrees as indicated by the dynamic heading indicator 108. The panoramic image on the right 102 shows a hallway 110 with a room entrance 112 to the left, which the floor plan image 104 clearly identifies as room 362 for the auditorium. Furthermore, the room hidden behind the wall 120 on the right shown on the floor plan image is the industrial lab. The floor plan dynamic heading indicator 108 is updated as the user pans or rotates the image. The user may close the interior two-dimensional floor plan image and is then properly re-oriented in the three-dimensional site model image.

As illustrated, the graphical user interface can be displayed on a video screen or other monitor 130 that is part of a personal computer 132, which includes a processor 134 operative with the 2D database 136 and 3D database 138. The processor is also operative with the associated database 140 as illustrated in the block components shown with the monitor 130.

The system could generate shells from modeling based upon satellite/aerial imagery and include building interior details. The system and method geospatially correlates two-dimensional imagery with three-dimensional site models and offers a data product that allows a user to identify quickly portions of a scene contained in interior imagery as it relates to a three-dimensional orientation. Typically, C++ code is used with different libraries and classes that represent different entities, such as a panoramic image or display with a built-in mechanism to maintain a three-dimensional position. The code is developed to synchronize and correlate images once the system enters the two-dimensional view and matches and reorients any two-dimensional images and three-dimensional site model images. A graphics library similar to Open GL can be used. Other three-dimensional graphics packages can be used.

The system can be augmented with the use of a three-dimensional packages such as the InReality™ application from Harris Corporation, including use of a system and method for determining line-of-sight volume for a specified point, such as disclosed in commonly assigned U.S. Pat. No. 7,098,915, the disclosure which is hereby incorporated by reference in its entirety or the RealSitet™ site modeling application also from Harris Corporation.

There now follows a more detailed description of the RealSite™ application that can be used as a complement to the correlation and synchronization as described above. It should be understood that this description of RealSite™ is set forth as an example of a type of application that can be used in accordance with a non-limiting example of the present invention.

A feature extraction program and geographic image database, such as the RealSite™ image modeling software developed by Harris Corporation of Melbourne, Fla., can be used for determining different geometry files. This program can be operative with the InReality™ software program also developed by Harris Corporation of Melbourne, Fla. Using this application with the RealSite™ generated site models, it is possible for a user to designate a point in three-dimensional space and find the initial shape of the volume to be displayed, for example a full sphere, upper hemisphere or lower hemisphere and define the resolution at which the volume is to be displayed, for example, 2°, 5° or 10° increments. It is also possible to define the radius of the volume to be calculated from the specified point The InRealty™ viewer system can generate a process used for calculating the volume and automatically load it into the InRealty™ viewer once the calculations are complete. A Line-of-Sight volume can be calculated by applying the intersection calculations and volume creation algorithms from a user selected point with display parameters and scene geometry as developed by RealSite™ and InRealty™, as one non-limiting example. This solution would provide a situation planner immediate information as to what locations in a three-dimensional space have a Line-of-Sight to a specific location within a three-dimensional model of an area of interest. Thus, it would be possible for a user to move to any point in the scene and determine the Line-of-Sight to the point. By using the InReality™ viewer program, the system goes beyond providing basic mensuration and displaying capabilities. The Line-of-Sight volumes can detail, in the three-dimensional site model, how areas are obscured in the synchronized two-dimensional imagery.

It is possible to use modified ray tracing for three-dimensional computer graphic generation and rendering an image. For purposes of description, the location, i.e., the latitude and longitude of any object that would effect the Line-of-Sight can be located and determined via a look-up table of feature extraction from the geographic image database associated with RealSite™ program. This geographic database could include data relating to the natural and man-made features in a specific area, including data about buildings and natural land formations, such as hills, which all would effect the Line-of-Sight calculations.

For example, a database could include information about a specific area, such as a tall building or water tower. A look-up table could have similar data and a system processor would interrogate and determine from the look-up table the type of buildings or natural features to determine the geometric features.

For purposes of illustration, a brief description of an example of a feature extraction program that could be used, such as the described RealSite™, is now set forth. The database could also be used with two-dimensional or three-dimensional feature imaging as described before. Optical reflectivity can be used for finding building plane surfaces and building edges.

Further details of a texture mapping system used for creating three-dimensional urban models is disclosed in commonly assigned U.S. Pat. No. 6,744,442, the disclosure which is hereby incorporated by reference in its entirety. For purposes of description, a high level review of feature extraction using RealSite™ is first set forth. This type of feature extraction software can be used to model natural and man-made objects. These objects validate the viewing perspectives of the two dimensional imagery and Line-of-Sight calculations, and can be used in two-dimensional and three-dimensional image modes.

RealSite™ allows the creation of three-dimensional models in texture mapping systems and extends the technology used for terrain texturing to building texture by applying clip mapping technology to urban scenes, It can be used to determine optical reflectivity values and even radio frequency reflectivity.

It is possible to construct a single image of a building from many images that are required to paint all the sites. Building site images can fit into a composite image of minimum dimension, including rotations and intelligent arrangements. Any associated building vertex texture coordinates can be scaled and translated to match new composite images. The building images can be arranged in a large “clip map” image, preserving the horizontal relationships of the buildings. If the horizontal relationships cannot be accurately preserved, a “clip grid” middle layer can be constructed, which can be used by the display software to accurately determine the clip map center.

At its highest level, the system creates a packed rectangle of textures for each of a plurality of three-dimensional objects corresponding to buildings to be modeled for a geographic site. The system spatially arranges the packed rectangle of textures in a correct position within a site model clip map image. The texture mapping system can be used with a computer graphics program run on a host or client computer having an OpenGL application programming interface. The location of a clip center with respect to a particular x,y location for the site model clip map image can be determined by looking up values within a look-up table, which can be built by interrogating the vertices of all building polygon faces for corresponding texture coordinates. Each texture coordinate can be inserted into the look-up table based on the corresponding polygon face vertex coordinate.

In these types of systems, the graphics hardware architecture could be hidden by a graphics API (Application Programming Interface). Although different programming interfaces could be used, a preferred application programming interface is an industry standard API such as OpenGL, which provides a common interface to graphics functionality on a variety of hardware platforms. It also provides a uniform interface to the texture mapping capability supported by the system architecture.

OpenGL allows a texture map to be represented as a rectangular pixel array with power-of-two dimensions, i.e. , 2^{m}×2ⁿ. To increase rendering speed, some graphics accelerators use pre-computed reduced resolution versions of the texture map to speed up the interpolation between sampled pixels. The reduced resolution image pyramid layers are referred to as MIPmaps by those skilled in the art. MIPmaps increase the amount of storage each texture occupies by 33%.

OpenGL can automatically compute the MIPmaps for a texture, or they can be supplied by the application. When a textured polygon is rendered, OpenGL loads the texture and its MIPmap pyramid into the texture cache. This can be very inefficient if the polygon has a large texture, but happens to be far away in the current view such that it only occupies a few pixels on the screen. This is especially applicable when there are many such polygons.

Further details of OpenGL programming are found in Neider, Davis and Woo, OpenGL Programming Guide, Addison-Wesley, Reading, Mass., 1993, Chapter 9, the Guide disclosure which is hereby incorporated by reference in its entirety.

Clip texturing can also be used, which improves rendering performance by reducing the demands on any limited texture cache. Clip texturing can avoid the size limitations that limit normal MIPmaps by clipping the size of each level of a MIPmap texture to a fixed area clip region.

Further details for programming and using clip texturing can be found in Silicon Graphics, IRIS Performer Programmer's Guide, Silicon Graphics, Chapter 10: Clip Textures, the Programmer's Guide, which is hereby incorporated by reference in its entirety.

IRIS Performer is a three-dimensional graphics and visual simulation application programming interface that lies on top of OpenGL. It provides support for clip texturing that explicitly manipulates the underlying OpenGL texture mapping mechanism to achieve optimization. It also takes advantage of special hardware extensions on some platforms. Typically, the extensions are accessible through OpenGL as platform specific (non-portable) features.

In particular, IRIS Performer allows an application to specify the size of the clip region, and move the clip region center. IRIS Performer also efficiently manages any multi-level paging of texture data from slower secondary storage to system RAM to the texture cache as the application adjusts the clip center.

Preparing a clip texture for a terrain surface (DEM) and applying it can be a straightforward software routine in texture mapping applications, as known to those skilled in the art. An image or an image mosaic is orthorectified and projected onto the terrain elevation surface. This single, potentially very large, texture is contiguous and maps monotonically onto the elevation surface with a simple vertical projection.

Clip texturing an urban model, however, is less straightforward of a software application. orthorectified imagery does not always map onto vertical building faces properly. There is no projection direction that will map all the building faces. The building textures comprise a set of non-contiguous images that cannot easily be combined into a monotonic contiguous mosaic. This problem is especially apparent in an urban model having a number of three-dimensional objects, typically representing buildings and similar vertical structures. It has been found that it is not necessary to combine contiguous images into a monotonic contiguous mosaic. It has been found that sufficient results are achieved by arranging the individual face textures so that spatial locality is maintained.

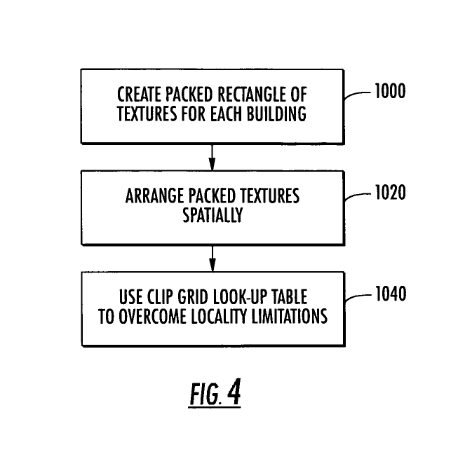

FIG. 4 illustrates a high level flow chart illustrating basic aspects of a texture application software model. The system creates a packed rectangle of textures for each building (block 1000). The program assumes that the locality is high enough in this region that the actual arrangement does not matter. The packed textures are arranged spatially (block 1020). The spatial arrangement matters at this point, and there are some trade-offs between rearranging things and the clip region size. A clip grid look-up table, however, is used to overcome some of the locality limitations (block 1040), as explained in detail below.

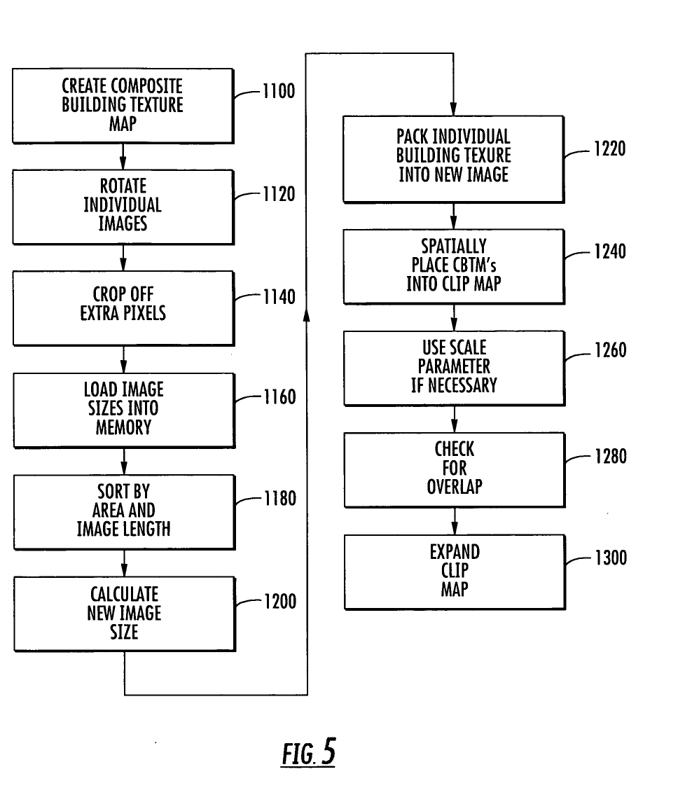

Referring now to FIG. 5, a more detailed flow chart sets forth an example of the sequence of steps that could be used. A composite building texture map (CBTM) is created (block 1100). Because of tiling strategies used later in a site model clip mapping process, all images that are used to texture one building are collected from different viewpoints and are packed into a single rectangular composite building texture map. To help reduce the area of pixels included in the CBTM, individual images (and texture map coordinates) are rotated (block 1120) to minimize the rectangular area inside the texture map actually supporting textured polygons. After rotation, extra pixels outside the rectangular footprint are cropped off (block 1140).

Once the individual images are pre-processed, image sizes for each contributing image are loaded into memory (block 1160). These dimensions are sorted by area and image length (block 1180). A new image size having the smallest area, with the smallest perimeter, is calculated, which will contain all the building's individual textures (block 1200). The individual building textures are efficiently packed into the new image by tiling them alternately from left to right and vice versa, such that the unused space in the square is minimized (block 1220).

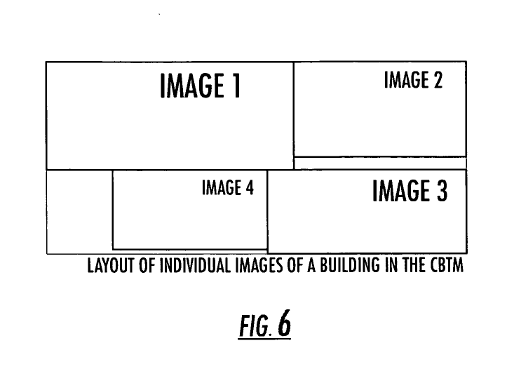

FIG. 6 illustrates an example of a layout showing individual images of a building in the composite building texture map. This is accomplished by an exhaustive search as described to calculate the smallest image dimensions describing each building.

A site model clip map image is next created. Because each composite building texture map (CBTM) is as small as possible, placing each one spatially correct in a large clip map is realizable. Initially, each composite building texture map is placed in its correct spatial position in a large site model clip map (block 1240). A scale parameter is used to initially space buildings at further distances from each other while maintaining relative spatial relations (block 1260). Then each composite building texture map is checked for overlap against the other composite building texture maps in the site model clip map (block 1280). The site model clip map is expanded from top right to bottom left until no overlap remains (block 1300). For models with tall buildings, a larger positive scale parameter may be used to allow for the increased likelihood of overlap. All texture map coordinates are scaled and translated to their new positions in the site model clip map image.

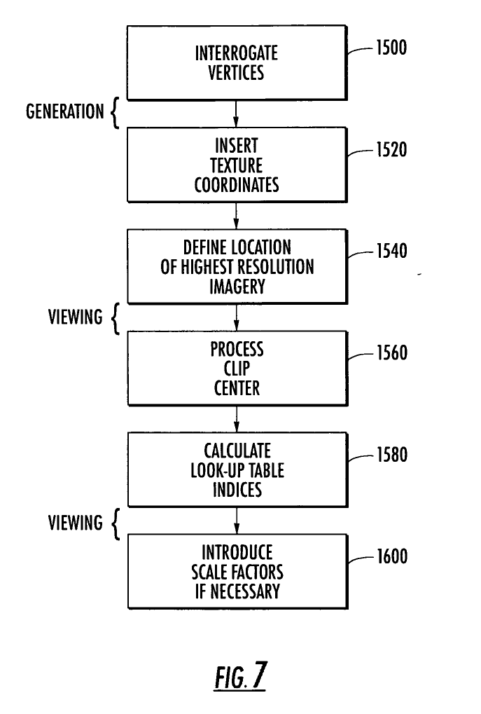

Referring now to FIG. 7, a flow chart illustrates the basic operation that can be used to process and display building clip textures correctly. A clip map clip grid look-up table is used to overcome these limitations and pinpoint the exact location of where the clip center optimally should be located with respect to a particular x,y location. To build the table, the vertices of all the building polygon faces are interrogated for their corresponding texture coordinates (block 1500). Each texture coordinate is inserted into a look-up table based on its corresponding polygon face vertex coordinates (block 1520).

A clip center or point in the clip map is used to define the location of the highest resolution imagery within the clip map (block 1540). Determining this center for a terrain surface clip map is actually achievable with little system complexity because a single clip texture maps contiguously onto the terrain elevation surface, so the camera coordinates are appropriate. The site model clip map has a clip center of its own and is processed according to its relative size and position on the terrain surface (block 1560). The site model clip map, however, does introduce some locality limitations resulting from tall buildings or closely organized buildings. This necessitates the use of an additional look-up table to compensate for the site model clip map's lack of complete spatial coherence. The purpose of the clip grid is to map three-dimensional spatial coordinates to clip center locations in the spatially incoherent clip map.

The clip grid look-up table indices are calculated using a x,y scene location (the camera position) (block 1580). If the terrain clip map and site model clip map are different sizes, a scale factor is introduced to normalize x,y scene location for the site model clip map (block 1600). It has been found that with sufficient design and advances in the development of the spatial correctness of the building clip map, the need for the clip grid look-up table can be eliminated in up to 95% of the cases.

It is also possible to extend the algorithm and use multiple site model clip maps. Using many smaller clip maps rather than one large clip map may prove to be a useful approach if clip maps of various resolutions are desired or if the paging in and out of clip maps from process space is achievable. However, it requires the maintenance of multiple clip centers and the overhead of multiple clip map pyramids.

The RealSite™ image modeling software has advantages over traditional methods because models can be very large (many km²) and can be created in days versus weeks and months of other programs. Features can be geodetically preserved and can include annotations and be geospatially accurate, for example, one meter or two meter relative. Textures can be accurate and photorealistic and chosen from the best available source imagery and are not generic or repeating textures. The InReality™ program can provide mensuration where a user can interactively measure between any two points and obtain an instant read-out on the screen of a current distance and location. It is possible to find the height of a building, the distance of a stretch of highway, or the distance between two rooftops along with Line-of-Sight information in accordance with the present invention. There are built-in intuitive navigation controls with motion model cameras that “fly” to a desired point of view. The InReality™ viewer can be supported under two main platforms and operating systems: (1) the SGI Onyx2 Infinite Reality2™ visualization supercomputer running IRIX 6.5.7 or later and an X86-based PC running either Microsoft WindowsNT 4.0 or Windows 98 or more advanced systems. The IRIX version of the InReality™ viewer can take full advantage of high-end graphics capabilities provided by Onyx2 such as MIPMapping in the form of clip textures, multi-processor multi-threading, and semi-immersive stereo visualization that could use Crystal Eyes by Stereo Graphics. InReality™ for Windows allows great flexibility and scalability and can be run on different systems.

Crystal Eyes produced by Stereo Graphics Corporation can be used for stereo 3D visualization. Crystal Eyes is an industry standard for engineers and scientists who can develop, view and manipulate 3D computer graphic models. It includes liquid crystal shutter eyewear for stereo 3D imaging.

Another graphics application that could be used is disclosed in commonly assigned U.S. Pat. No. 6,346,938, the disclosure which is hereby incorporated by reference in its entirety.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An imaging system, comprising:
a 3D database for storing data relating to a three-dimensional site model having vantage point positions and orientations when displayed;
a 2D database for storing data relating to two-dimensional images that correspond to vantage point positions and orientations for the three-dimensional site model;
a display for displaying both the three-dimensional site model image and two-dimensional imagery; and
a processor operative with the 2D and 3D databases and the display for creating and displaying the three-dimensional site model image and two-dimensional imagery from data retrieved from the 2D and 3D databases and correlating and synchronizing the three-dimensional site model image and two-dimensional imagery to establish and maintain a spatial orientation between the images as a user interacts with the system.

2. The imaging system according to claim 1, and further comprising a graphical user interface on which the three-dimensional side model and two-dimensional images are displayed.

3. The imaging system according to claim 1, and further comprising said three-dimensional site model image and said two-dimensional images such as a panoramic view obtained at an image collection point within a building interior and a floor plan image centered on the image collection point within the building interior.

4. The imaging system according to claim 3, wherein said processor is operative for rotating the panoramic image and updating the floor plan image with a current orientation of the panoramic image for purposes synchronizing said two-dimensional imagery with the three-dimensional site model image.

5. The imaging system according to claim 1, and further comprising a dynamic heading indicator that is displayed and synchronized to a rotation of the three-dimensional site model image.

6. The imaging system according to claim 1, wherein said processor is operative for updating at least one of said 2D and 3D databases based upon additional information obtained while a user interacts with an image.

7. The imaging system according to claim 1, wherein said 2D database comprises rasterized vector data.

8. The imaging system according to claim 1, wherein said 3D database comprises data for a Local Space Rectangular or world Geocentric coordinate system.

9. The imaging system according to claim 1, and further comprising an associated database operative with said 2D and 3D databases for storing ancillary data to the 2D database and 3D database and providing additional data that enhances the two and three dimensional data displayed during user interaction with the system.

10. A imaging method, comprising:
creating and displaying a three-dimensional site model image having a selected vantage point position and orientation;
creating a two-dimensional image when the vantage point position and orientation for the three-dimensional site model image corresponds to a position within the two-dimensional image; and
correlating and synchronizing the three-dimensional site model image and two-dimensional image to establish and maintain a spatial orientation between the images as a user interacts with the system.

11. The method according to claim 10, which further comprises displaying the two-dimensional imagery and the three-dimensional image site model image on a graphical user interface.

12. The method according to claim 10, which further comprises capturing the three-dimensional site model image at an image collection point and displaying the two-dimensional image at the same spatial orientation of the three-dimensional site model at the image collection point.

13. The method according to claim 10, which further comprises associating with each image a spatial position and collection point azimuth angle.

14. The method according to claim 10, which further comprises displaying a dynamic heading indicator that is synchronized to a rotation of the three-dimensional site model image.

15. The method according to claim 10, which further comprises storing data relating to the two-dimensional image within a 2D database, storing data relating to the three-dimensional site model image within a 3D database, and updating the data within at least one of the 2D and 3D databases as a user interacts with the system.

16. The method according to claim 10, which further comprises creating the two-dimensional image from rasterized vector data.

17. The method according to claim 10, which further comprises creating the three-dimensional site model image from data in a Local Space Rectangular or World Geocentric coordinate system.

18. A method for displaying images, comprising:
displaying a three-dimensional model image;
displaying a panoramic image of a building interior having a vantage point position and orientation obtained at an image collection point within the building interior;
displaying a two-dimensional floor plan image centered on the collection point of the panoramic image; and
correlating and synchronizing the three-dimensional model image, panoramic image and floor plan image to establish and maintain a spatial orientation between the images as a user interacts with the system.

19. The method according to claim 18, which further comprises rotating the panoramic image and updating the two-dimensional floor plan image with a current orientation of the three-dimensional model image.

20. The method according to claim 19, which further comprises displaying a dynamic heading indicator that is synchronized to any rotation of the three-dimensional model image.

21. The method according to claim 18, which further comprises displaying the two-dimensional floor plan image and the panoramic image on a graphical user interface.

22. The method according to claim 18, which further comprises marking an image collection point for the two dimensional imagery on the three-dimensional model image.

23. The method according to claim 18, which further comprises storing data relating to the two-dimensional imagery within a 2D database, storing data relating to the three-dimensional model within a 3D database, and updating data as a user interacts with the system.

24. The method according to claim 18, which further comprises creating the two-dimensional floor plan image from rasterized vector data.

25. The method according to claim 18, which further comprises creating the three-dimensional site model image from data comprising a Local Space Rectangular or World Geocentric coordinate system.
